(19) United States
(12) Patent Application Publication
(10) Pub. No.: US 2005/0187710 A1
(43) Pub. Date: Aug. 25, 2005

(54) Vehicle navigation system turn indicator

(76) Inventor: James A. Walker, Trevor, WI (US)

Correspondence Address: MOTOROLA, INC., 1303 EAST ALGONQUIN ROAD, IL01/3RD, SCHAUMBURG, IL, 60196, US

(21) Appl. No.: 10/782,989

(22) Filed: Feb. 20, 2004

(51) Int. Cl. G01C 21/34

(52) U.S. Cl. 701/211; 340/995.2

(57) ABSTRACT

A navigation system for a vehicle for providing improved notification of upcoming turns along a given route is disclosed. Such turn notifications preferably involve activating turn signal indicators within or external to the vehicle in response to turn notification signals supplied by the navigation system. Such preexisting turn signal indicators include the dedicated turn signal indicators normally present within or on the vehicle, such as the turn signal indicators on the instrument cluster on the vehicle's dashboard; the external turn signal lights typically proximate the front and rear bumpers of the vehicle; the turn signal indicators integrated with the side mirror, or similar indicators. Because preexisting turn signal indicators are used, turn notification is made simpler and more economical as additional indicators or indicator systems are not necessary. Moreover, using indictors interior and exterior to the vehicle benefits both the vehicle occupant and well as other vehicles in the vicinity of the occupant's vehicle to inform of the occupant's intended route. In addition to using preexisting dedicated turn signal indicators, a heads up display can be used to display the turn notification, which is beneficial because it is substantially within the occupant's line of sight.

### FIELD OF THE INVENTION

This invention relates to systems and methods for indicating a turn in a vehicle having access to a navigation system.

### BACKGROUND

Communication and informational systems in vehicles continue to grow more powerful, thus providing increasing convenience to vehicle occupants. For example, some vehicles are now equipped with relatively sophisticated computer systems to enhance the driving experience and to provide useful information to vehicle occupants. Such vehicle-based systems may also wirelessly communicate with even more powerful computing systems external to the vehicle.

An increasingly popular computerized feature found in some vehicles is a navigation system. Such systems come in a variety of forms. In one form, a vehicle occupant uses a user interface in his vehicle to specify a desired destination or route of travel, sometimes in conjunction with a computerized map displayed on a user interface display. If a mere destination is specified, the optimal route to reach that destination can be computed by the navigation system in the vehicle (and/or at a server in wireless communication with the vehicle). The vehicle in such a system will be equipped with some sort of location-specifying device, such as a Global Positioning System (GPS) device, to determine the exact location of the vehicle (and/or to wirelessly transmit that location to the server). The car (and/or the server), using the GPS data, tracks the location of the vehicle, and can chart the vehicle's progress along the route, perhaps by displaying the route and/or location of the vehicle on a map associated with the user interface display.

When the occupant nears a turn along the route, the navigation system can notify the occupant about the upcoming turn, and preferably does so in advance of the turn (e.g., 50 feet in advance). Such a turn notification can come in a variety of forms. For example, the navigation system can visually notify the occupant of the turn though updating the graphics on the user interface display, e.g., by displaying a text message (“right turn ahead”), by a flashing arrow, etc., which may or may not be associated with a map of the route or destination. Alternatively, the notification can be audible. For example, a computerized voice can tell the occupant about the “right turn ahead,” which voice may be broadcast through the speakers normally resident in the vehicle (e.g., the radio speakers) or through a dedicated user interface speaker or speakers. Moreover, such notification can be both audial and visual, for example, by audibly broadcasting a “beep” along with displaying a visual indication of the turn ahead on the user interface display.

But current navigational systems are not optimal, and suffer from drawbacks that hamper their utility. The notification of upcoming turns, be it audial or visual, may only be fleeting, and therefore may be missed by a busy or inattentive occupant. Moreover, turn notifications may simply go unnoticed: audial notifications may not be easily heard given the noise level in the vehicle, and visual notifications may go unnoticed because they are not presented within the occupant's line of sight while driving. In this regard, it is worth noting that user interface displays are typically located in the center of the vehicle's dashboard, requiring the user to look away from the front, potentially creating a safety hazard. Moreover, while current navigational systems may be useful to inform the vehicle occupant regarding upcoming turns on the occupant's intended route, such systems do nothing to alert other drivers (e.g., those behind or in front of the occupant) of such upcoming turns. This too can present a safety hazard, particularly if the occupant realizes too late that he has been alerted to make a turn, and attempts at the last minute to do so when it may be unsafe.

In short, room exists to improve upon current navigational systems, and this disclosure presents solutions.

### SUMMARY OF THE INVENTION

Disclosed herein are systems and methods for notifying of an upcoming turn in a vehicle traveling along a route. In one aspect, a method implementing the invention comprises electronically generating a turn notification signal upon electronically determining that the vehicle is approaching a turn along the route, and automatically illuminating at least one turn signal indicator associated with the vehicle in response to the turn notification signal. The turn signal indicator can comprise an indicator proximate to an instrument cluster on a dashboard of the vehicle, such as the standard left/right arrows; a turn signal indicator that is external to the vehicle, such as standard indicators proximate to the front and rear bumper and/or the side view mirrors; a turn signal indicator that is otherwise independently activatable by a driver of the vehicle using a turn signal selector, such as the turn signal lever coupled to the steering column. Furthermore, the turn signal indicator can comprise an indicator which is otherwise substantially within the line of sight of a driver of the vehicle, such as image reflected from the front windshield by a “heads up” display or illumination of other indicators external to the vehicle and placed within the driver's line of sight. Such “line of sight” embodiments are preferable for safety reasons and because they are unlikely to be missed by the driver. The turn signal indicators can comprise indicators not normally integrated with the vehicle at the time of their manufacture. For example, the indicators may comprise “after-market” indicators which are installed in or on the car and preferably substantially within the line of sight of the driver, such as on the hood of the vehicle, on the hood ornament, etc., but which can occur elsewhere (e.g., on the bumper) for the benefit of other vehicles.

In still further refinements, generation of the turn notification signal comprises determining the location of the vehicle relative to the location of the turn, which preferably includes the use of a Global Positioning System, and which informs the system when the vehicle is within a certain distance of the turn. Generation of the turn notification signal can comprise use of a server in wireless communication with the vehicle, which may have preferable processing resources for some applications. Although the turn signal indicators are automatically engaged using the disclosed methods, they are also preferably independently activatable by a driver of the vehicle, for example, through manipulation of the turn signal lever or through the use of some other turn signal selector. Moreover, automatic illumination of the turn signal indicators can be overridden by the driver, and/or can be extinguished when the driver has passed through the turn at issue.

Illuminating the turn signal indictor may also be accompanied by an audible turn notification within the vehicle, which is also asserted in response to the turn notification signal. The audible turn notification can comprise, for example, a voice specifying the nature of the upcoming turn (“right” or “left”), or can emulate the sound heard upon engagement of an electromechanical device, such as a relay or solenoid coupled to the turn signal lever.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 illustrates a wireless communication and information system including a server and vehicles in communication with the server.

FIG. 2 illustrates the electronics within a vehicle in which various embodiments of the invention can be used.

FIG. 3 illustrates the inside of a cabin of a vehicle, including a user interface for communicating with the electronics of FIG. 2, a turn signal level, and turn signal indicators on the instrument cluster of the dashboard.

FIG. 4 illustrates the exterior of the rear end of a vehicle, including rear turn signal indicators and side view mirror turn signal indicators.

FIG. 5 illustrates the electronics for sending a turn notification to the turn signal indicators inside or outside the vehicle and/or to the heads up display.

FIG. 6 illustrates an exemplary display screen in the user interface for allowing a user to choose which turn signal indicators will be illuminated upon receipt of a turn notification from the navigation system.

FIG. 7 illustrates a flow chart explaining engaging, overriding, and resetting of the turn notifications generated by the navigation system.

FIG. 8 illustrates displaying a turn notification using a heads up display.

### DETAILED DESCRIPTION

Disclosed herein is a navigation system for a vehicle for providing improved notification of upcoming turns along a given route. Such turn notifications preferably involve automatically activating turn signal indicators within or external to the vehicle in response to turn notification signals supplied by the navigation system. Such turn signal indicators include the dedicated turn signal indicators normally present within or on the vehicle, such as the turn signal indicators on the instrument cluster on the vehicle's dashboard; the external turn signal lights typically proximate the front and rear bumpers of the vehicle; the turn signal indicators integrated with the side mirror, or similar indicators. When preexisting turn signal indicators are used, turn notification is made simpler and more economical as additional indicators or indicator systems are not necessary, although other after market turn signal indicators could also be used. Moreover, using indicators interior and exterior to the vehicle benefits both the vehicle occupant and well as other vehicles in the vicinity of the occupant's vehicle to inform of the occupant's intended route. In addition to using dedicated turn signal indicators, a heads up display can be used to display the turn notification, which is beneficial because it is substantially within the occupant's line of sight. Before explaining embodiments of these implementations, the system in which such implementations can be used is described in some detail, with details of the inventive implementations to follow.

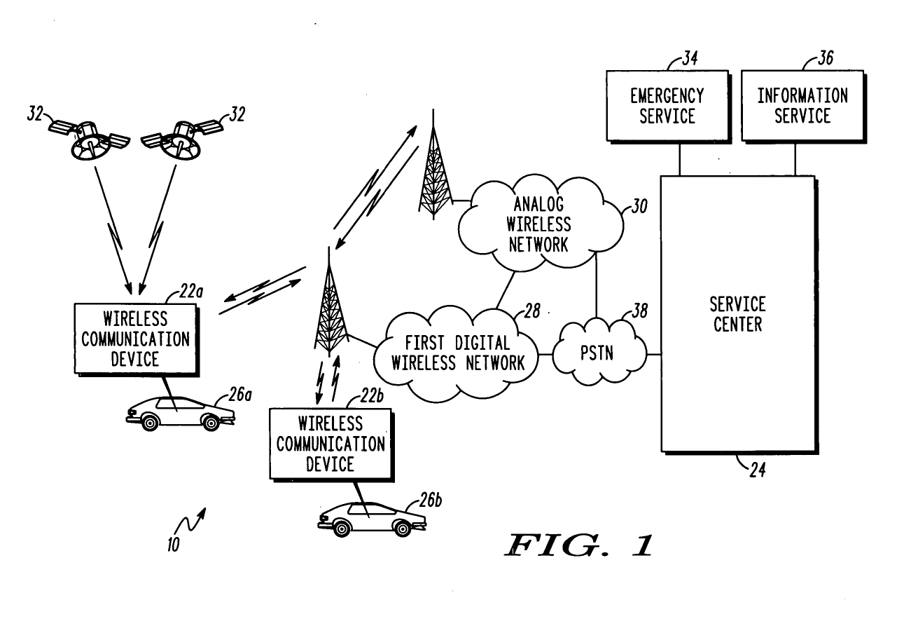

FIG. 1 shows an exemplary vehicle-based communication and informational system 10. In this system, vehicles 26 are equipped with wireless communication devices 22, which can wirelessly transmit or receive information to or from a transceiver tower coupled to a digital wireless network 28, which in turn may further transmit information to or receive information from an analog wireless network 30 if necessary or appropriate. Moreover, the wireless communication devices 22 may receive information from satellites 32, which is particularly useful in conjunction with GPS capabilities of the disclosed system which will be discussed in further detail later. Ultimately, either network may be coupled to a public switched telephone network (PSTN) 38 on route to a service center 24, which ultimately acts as the host for the communication system 10. As well as administering communications between vehicles 26 wirelessly connected to the system, and providing information to each vehicle 26 on an individualized basis, service center 24 can provide other services to the vehicles 26, such as emergency services 34 or other information services 36 (such as restaurant services, directory assistance, mapping programs, etc.).

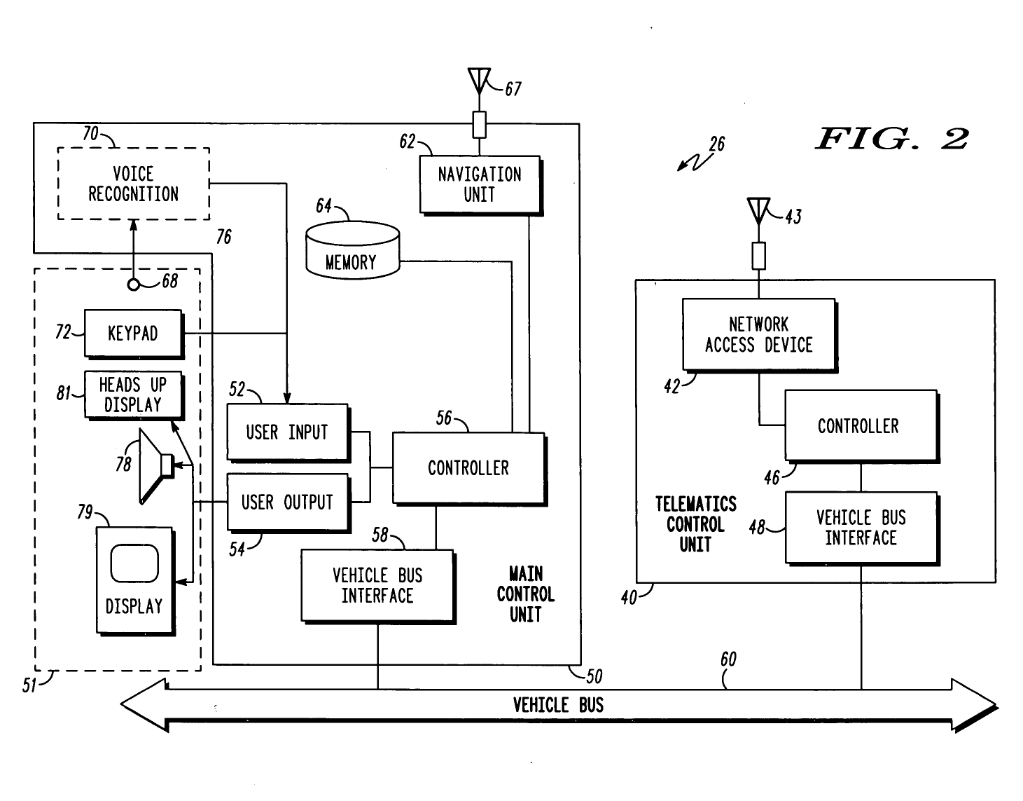

Further details of the electronics within vehicle 26 are shown in FIG. 2. The electronics include a main control unit 50 and a telematics control unit (TCU) 40. The main control unit 50 controls and administers communication and informational processing within the vehicle, and interfaces with or includes a user interface 51 with which the vehicle occupants interacts to send or receive communications or information. The main control unit 50 may include a microphone 68, a keypad 72, speaker(s) 78, and a display 79. These components within the user interface 51 may be integrated into a single unit (and, for example, integrated within the dashboard of the vehicle), or may be distributed throughout the vehicle. For example, the speakers 78 may comprise the standard radio speakers or may constitute a dedicated speaker or speakers. Additionally or alternatively to the display 79, the main control unit 50 may include a “heads up display” module 81 for visibly displaying information from the system via reflection from the front windshield as is known.

The main control unit 50 also comprises a navigation unit 62, which typically includes a Global Positioning Satellite (GPS) system for allowing the vehicle's location to be pinpointed, which is useful in the context of the invention for reasons to be explained later. As is known, the navigation unit 62 communicates with GSP satellites (such as satellites 32) via a receiver 67. Ultimately communications and information are processed by a controller 56. A memory 64 is coupled to the controller 56 to store data and processes for use in the system, such as, for example, a mapping and route generation program. The controller 56 also communicates via a vehicle bus interface 58 to a vehicle bus 60, which carries information and other data pertinent to vehicle operation throughout the vehicle.

TCU 40 is similarly coupled to the vehicle bus 60, and hence the main control unit 50. The TCU 40 is essentially responsible for sending and receiving voice or data communications to and from the vehicle, i.e., wirelessly to and from the rest of the communications system 10 and most importantly to the server 24. TCU 40 comprises a telematics controller 46 to organize such communications, and a network access device 42 which include a wireless transceiver 43. Although shown as separate components, one skilled in the art will recognize that aspects of the main control unit 50 and the TCU 40 can be combined or swapped.

Alternatively, and although not shown in the Figures, the TCU 40 could be coupled to another device present in the vehicle having wireless capability. For example, the vehicle occupant's cell phone may be used for this purpose, which may be wired to the TCU 40 and/or in wireless communication with the TCU 40 (e.g., using Bluetooth technology). Moreover, the GPS capability when using such an alternative device such as a cell phone may reside in the cell phone or in the TCU 40. Thus, the TCU 40 need not necessarily itself contain a wireless access device.

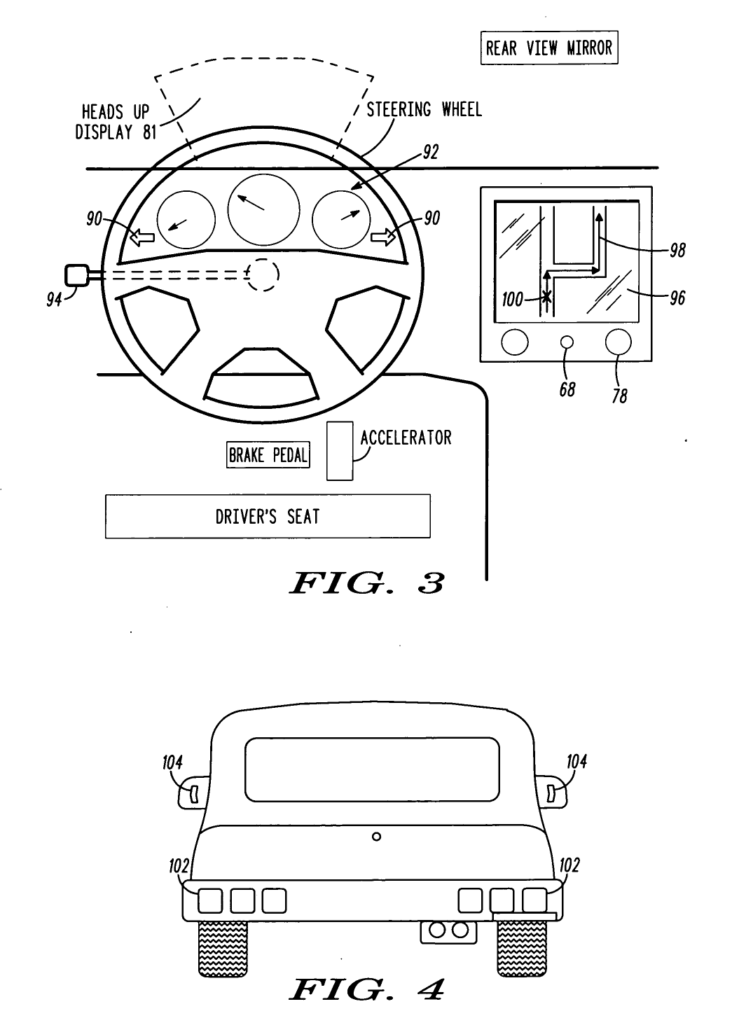

FIG. 3 shows the inside of the front cabin of a vehicle 26, including aspects of the user interface 51 discussed earlier. Also shown are the turn signal indicators 90 on the instrument cluster 92, as well as the turn signal lever 94 which allows the occupant to manually signal either a left or right turn by rotating the lever up or down as is well known. Also shown on display 79 is a map 96 showing the defined or computed route 98 as well as the present location 100 of the vehicle (“X”). Use of display 79 however is not necessary in all implementations of the disclosed invention.

FIG. 4 shows the rear end of the outside of a vehicle 26, including as is most relevant here the external turn signal indicators 102 for signaling to other vehicles the occupant's desire to make either a left or right turn, and which are located proximate to the rear bumper. Similar external turn signal indicators on the front of the vehicle are not shown for clarity. Alternatively, such external turn signal indicators may be integrated elsewhere on the vehicle 26, such as on the external side view mirrors 104.

With these concepts understood, embodiments of the invention can be set forth with more clarity. As noted earlier, traditional navigation systems provide the occupant a notification of an upcoming turn in advance of that turn (e.g., 50 feet). Such notification can be generated given the knowledge of the position of the car (e.g., from the navigation unit 62 and its GPS capabilities) and knowledge of the route (which may be automatically generated or user specified). Ultimately, such a turn notification can be generated within the vehicle 26 or external to the vehicle at server 24, or both. For example, assume the route information 98 is stored within the vehicle at memory 64. (In this regard, note that generation of the route might depend on where a suitable mapping program is located within the system. If located within the vehicle 26, route generation may be effected at the vehicle; if the mapping program is resident at the server 24, the route may be calculated at the server 24 and sent to the vehicle 26 for storage). Because the vehicle coordinates are known to the vehicle via the navigation unit 62, the controller 56 can compare the route and the current location to decide whether to output a turn notification to the occupant.

Similarly, whether a turn notification is appropriate can be assessed external to the vehicle 26. Thus, the GPS coordinates may be sent from the vehicle 26 to the server 24 through the TCU 40, and if the server 24 contains the route 98, it can determine when a turn notification signal is appropriate, and broadcast this to the occupant's vehicle 26 for processing and output, again using controller 56. Of course, should any external processing be necessary, one skilled in the art will realize that the information sent wirelessly between the vehicle 26 and the server 24 will be accompanied by a suitable header indicative of the identification code for the vehicle 26, which code will be correlated with the various vehicle-dependent files (e.g., route files) stored at the server 24. In short, determining and generating a turn notification may be achieved in several different ways using the computing facilities present at the vehicle 26 and at the server 24.

Regardless, ultimately the turn notification is received at the controller 56 for processing. As noted, in the prior art, ultimately such a turn notification resulted in some form of output to the user interface 51, such as some form of visual notification on the display 79 and/or some form of audible notification from speaker(s) 78. However, as noted, such prior approaches suffer from drawbacks. Turn notifications may simply go unnoticed by the occupant. Moreover, such notifications, to the extent they are visual in nature, are not within the occupant's line of sight to the extent they are present on the user interface console in the middle of the dashboard. Additionally, prior art turn notifications are not cognizable to other vehicles in the vicinity of the occupant's vehicle 26.

Accordingly, in some embodiments of the invention, existing turn notification mechanisms in the vehicle are used to inform the occupant of upcoming turn notifications, and/or to inform other vehicles of the occupant's upcoming turn notifications. In a preferred embodiment, such notification is achieved by activating the turn signal indicators 90 associated with the instrument cluster 92 on the vehicle's dashboard (FIG. 3), and/or by activating the external turn signal indicators 102 (or side view mirror turn signal indicators 104) (FIG. 4) to inform other vehicle's of the occupant's intention to turn. This provides substantial benefits. Illumination of the internal turn signal indicators 90 is within the driver's line of sight and therefore unlikely to be missed, which is convenient and mitigates potential safety hazards. Illumination of the external turn signal indicators 102 benefits other vehicles, which are alerted to the occupant's intended route and thus have time to prepare for the occupant's impending turns. Side view mirror indicators 104 similarly benefit both the occupant and other vehicles in the vicinity. Moreover, use of these dedicated indicators means that additional indicators need not be added to the vehicle 26, saving cost and easing implementation.

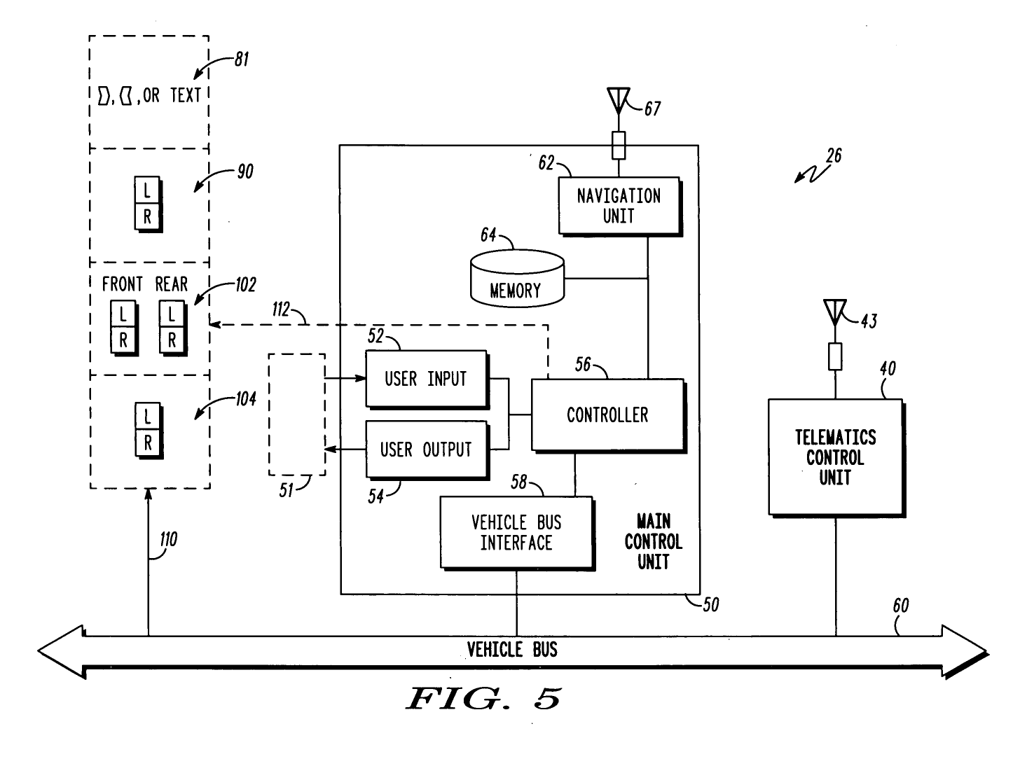

Means for activating these indicators are shown in FIG. 5. In an embodiment in which the vehicle bus 60 has access to and can control these various turn signal indicators, receipt of a turn notification signal (from the navigation unit 62, from the server 24, etc.), causes the controller 56 to send a signal or signals 110 through the vehicle bus 60 indicating the turn signal indicator (90, 102 and/or 104) to be illuminated and type of turn projected by the route (either left or right). This signal is ultimately sent to the turn signal indicator(s) themselves for proper illumination. The exact form of the illumination signal will depend on the protocol used for the vehicle bus 60 and in particular how that protocol requires packetization of the information to control the indicators, which may be accomplished in several different ways.

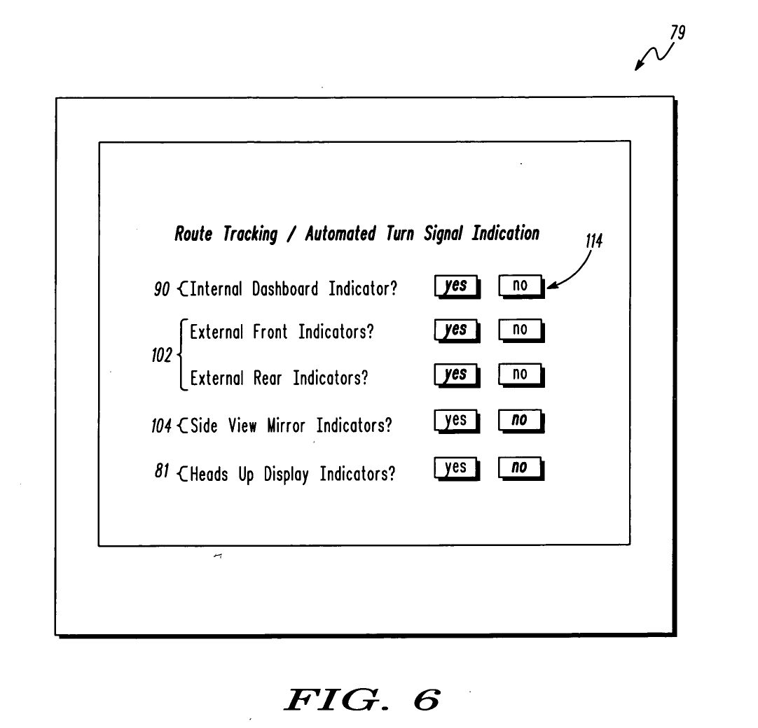

As noted, the controller 56 will determine which of the indicators should be illuminated. For example, if desired to notify both the occupant and other drivers, perhaps all turn signal indicators 90, 102, and 104, be they internal or external, will be illuminated, which may be a matter specifiable by the occupant. For example, and as shown in FIG. 6, a menu accessible through the display 79 on the user interface 51 allows the occupant to specify which of the various indicators will be illuminated upon receipt of turn notifications by the navigation system, and in the example shown indicators 90 and 102 has been selected by the use of touch screen buttons 114. Such preferences may then be stored either within the main control unit 50 (e.g., at memory 64) or at the server 24. Alternatively, which indicators will be illuminated by the system may be preset and made unchangeable.

If the vehicle's vehicle bus 60 does not contain information for or allow control of the turn signal indicators, or cannot be so modified, the main control unit 50 may alternatively send activation signals to the indicators through a separate dedicated signaling path 112 (FIG. 5) which preferably directly couples to such indicators (and/or their associated logic). Of course, such a path must be capable of handling signal to both the left and right indicators. It should be appreciated that the disclosed inventive systems and methods need not be integrated with preexisting electronics in the vehicle upon their manufacture. As one skilled in the art will appreciate, modules encompassing the requisite hardware and/or software to implement the invention can constitute an “after market” feature which can later be coupled to the vehicle's preexisting electronics to perform the turn signal notification functions described herein.

Further refinements are possible. In particular, an audible notification of upcoming turns can be broadcast to the occupant concurrently with engagement of the turn signal indicators. For example, a computerized voice, a chime, a beep, an alarm, etc., may be broadcast concurrently with the visual turn signal notification, such as though speaker(s) 78, which again can either constitute a dedicated speaker(s) at the user interface 51 or the vehicle's standard audio speakers as made accessible through the vehicle bus 60. In a preferred embodiment keeping with the spirit of using turn signal indicators as the visual notification of upcoming turns, the “click” noise that the occupant would otherwise hear when manually engaging the turn signal lever 94 (FIG. 3) can be emulated. This is preferred as it is a sound that the occupant is naturally accustomed to hearing when the turn signals are engaged. One skilled in the art will realize that this “click” noise often results from activation of an electromechanical device (such as a relay or solenoid) upon manipulation of the lever 94. Accordingly, emulation of the “click” noise can be achieved through having the controller 56 send a signal to such devices to cause them to close and thereby causing them to emit their native “clicks,” even though the lever 94 has not been manipulated. (This approach is particularly suitable because engagement of the electromechanical devices will also normally cause the turn signal indicators (90, 102, 104, etc.) to illuminate). Alternatively, a recording of a click sound can stored and broadcast through the speaker(s) 78, or the click sound could emulate from a chime module or piezo-electric element to the same effect. Although it is preferred that audible and visual notification occurs simultaneously, they can be staggered, for example, with visual notification coming 50 feet prior to a turn, and audible notification coming as a reminder 25 feet from the turn.

Although the turn signal lever 94 is not normally controlled in its rotational movement by a motor, in an alternative embodiment the lever can be so controlled, and activation of the turn signal indicators to notify the occupant of an upcoming turn can comprise manually controlling that motor to mechanically move the lever 94.

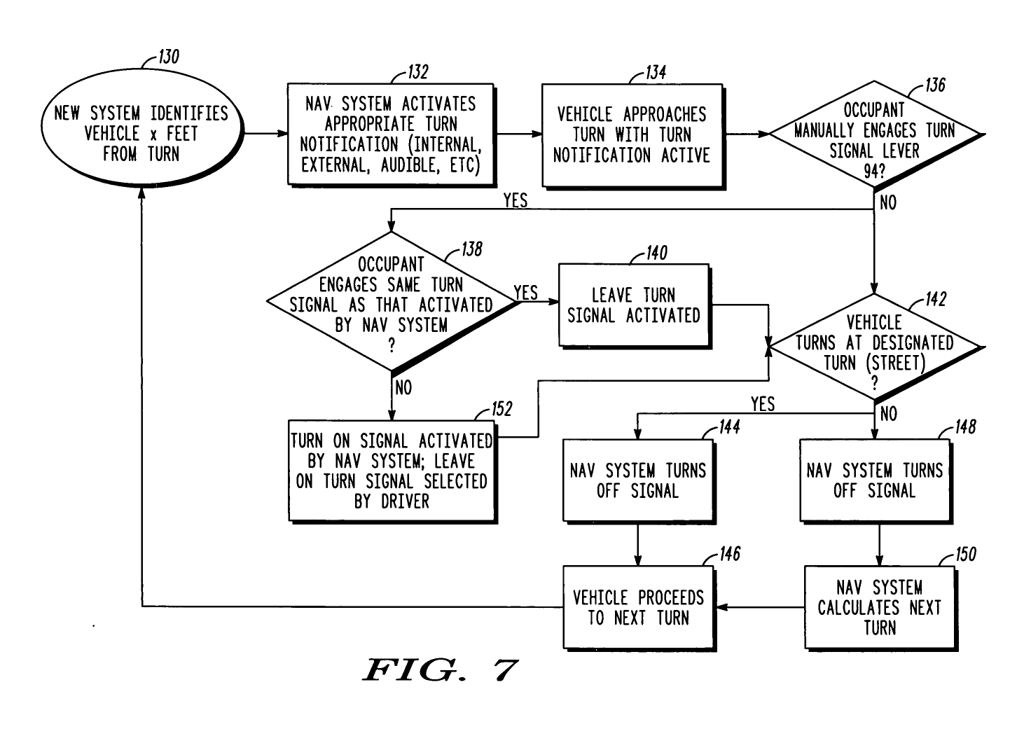

FIG. 7 illustrates the operation of the embodiments described above in an actual driving application. Ultimately this process illustrated in the flow chart is preferably controlled by the controller 56 in the main control unit 50, with the necessary routines stored in memory 64. The process starts (130) when the navigation system determines whether the vehicle 26 is a certain distance from a given turn along the route using the vehicle's GPS coordinates. If so, the navigation system activates the appropriate turn notification as described above, i.e., by activation of one of the vehicle's turn signal indicators (without or without an audible notification (132)). As the vehicle approaches the turn (134), the vehicle queries whether the occupant has manually engaged the turn signal lever 94 (136) to activate a turn signal indicator. In this regard, position of the turn signal lever 94 is reported back to the controller 56, preferably along the vehicle bus 60, but optionally through a dedicated path (similar to path 112; see FIG. 5). If the turn signal lever 94 has been manually engaged, the system checks to see whether the position of the lever 94 matches the direction of the turn automatically specified by the navigation system (138), and if so, that turn signal indicator is left active. If the lever 94 does not match (e.g., if the occupant decides to deviate from the specified route by turning left instead of right), then the user's manual selection is honored and the turn signal direction automatically specified by the navigation system (right) is overridden (152) and the other (left) turn signal indicator is illuminated. If however the occupant does not manually engage the turn signal lever 94, an assessment is made again whether the occupant indeed turned at the designated turn (142). This assessment is preferably made using GPS coordinates, but could also be used by assessing the status of the vehicle's compass which would indicate a change in heading. If the turn was made, the navigation system turns off the turn signal (144) and the vehicle proceeds to the next turn (146). If the turn was not made (e.g., if the occupant decides to deviate from the specified route), then again the navigation system turns off the turn signal (148), and the next turn required to direct the occupant back to the specified route is calculated (150). In this regard, recalculating the route can be performed much in the same way that the initial route was computed, and as mentioned earlier can be computed with the vehicle 26 or at the server 24.

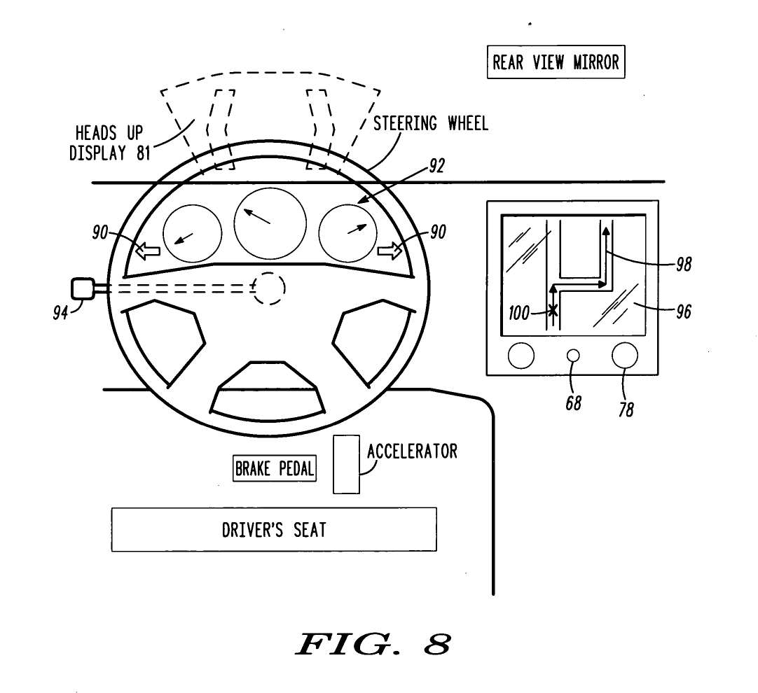

Other solutions are possible not requiring the use of standard indicators normally present on standard vehicles. In this regard, one goal of the various solutions presented herein is to provide an occupant a clear indication of when his navigation system is notifying him of a turn in a manner non disruptive and safe manner. Accordingly, an optimal solution, to the extent it is visual, requires a notification that does not require the occupant to substantially divert his eyes from the road. Accordingly, instead of indicating turn notifications to the occupant using internal turn signal indicators (e.g., 90), the heads up display 81 can also be used, such as is illustrated in FIGS. 5 and 8. This solution, like the use of dashboard turn signal indicators 90, provides a good indication to the occupant of upcoming turns because it is well within the occupant's line of sight while driving. This is therefore a preferable and safer solution when compared to approaches that display turn notifications on a display 79 or other console to the right of the driver on the dashboard (see FIG. 3), and for purposes of this disclosure such center-mounted consoles should not be understood as substantially within the occupant's line of sight. The notification as displayed on the heads up display may constitute arrows as shown in FIG. 8, or may constitute a textual message (e.g., “turn right.”). Again, this embodiment may be used in conjunction with audible indicators as disclosed earlier.

Furthermore, other types of non-standard turn signal indicators could be used and preferably would also be placed somewhere on the vehicle substantially within the occupant's line of sight. Such turn signal indicators might be “after market” turn signal indicators, which are not manufactured into the vehicle but are purchased and installed on the vehicle after the fact. Such indicators could be wired to the controller 56, and if they are after market indicators, might be most easily installed through the use of a dedicated path, such as path 112 in FIG. 5, to function in response to the turn notifications from the navigation unit, although they could also be made controllable through the vehicle bus 60. Such non-standard after market turn signal indicators could be located in a variety of locations on the vehicle, such as on the hood of the car, on the hood ornament, on the windshield, near the top of the windshield, all of which would be substantially in the occupant's line of sight. Of course, such indicators could also be placed in locations to benefit other vehicles, such as on the side of the car, on the bumper, underneath the chassis, etc. Such indicators could constitute lights or light strips and could be affixed to left and right sides of the vehicle by a variety of different means (bolting, gluing, epoxy, etc.). Although such alternative turn signal indicators are preferably after market add-ons to the vehicle, they could also be integrated with the vehicle during its manufacture.

“Proximate” as used herein should be understood as “near” or “on.” For example, saying that the external turn signal indicators 102 are proximate to the vehicle's bumpers implies that the indicators can be near the bumper or located on the bumper.

It should be understood that the inventive concepts disclosed herein are capable of many modifications. To the extent such modifications fall within the scope of the appended claims and their equivalents, they are intended to be covered by this patent.

1. A method for notifying of an upcoming turn in a vehicle traveling along a route, comprising:
electronically generating a turn notification signal upon electronically determining that the vehicle is approaching a turn along the route; and
automatically illuminating at least one turn signal indicator associated with the vehicle in response to the turn notification signal, wherein the turn signal indicator comprises an indicator proximate to an instrument cluster on a dashboard of the vehicle.

2. The method of claim 1, wherein generating the turn notification signal comprises determining the location of the vehicle relative to the location of the turn.

3. The method of claim 2, wherein determining the location of the vehicle comprises use of a Global Positioning System.

4. The method of claim 2, wherein determining the location of the vehicle relative to the location of the turn comprises determining whether the location of the vehicle is within a certain distance of the turn.

5. The method of claim 1, wherein generating the turn notification signal comprises use of a server in wireless communication with the vehicle.

6. The method of claim 1, wherein the turn signal indicator is independently activatable by a driver of the vehicle.

7. The method of claim 6, wherein the turn signal indicator is independently activatable by the driver by manipulating a lever coupled to a steering column in the vehicle.

8. The method of claim 1, further comprising audibly broadcasting an audible turn notification within the vehicle in response to the turn notification signal.

9. The method of claim 8, wherein the audible turn notification comprises a voice specifying the nature of the upcoming turn.

10. The method of claim 1, wherein the audible turn notification emulates the sound heard upon engagement of an electromechanical device.

11. The method of claim 1, further comprising allowing the driver to override the automatically illuminated turn signal indicator.

12. The method of claim 1, further comprising disabling the illumination of the illuminated turn signal after the vehicle has passed the turn.

13. The method of claim 1, further comprising illuminating a turn signal indicator which is external to the vehicle in response to the turn notification signal.

14. A method for notifying of an upcoming turn in a vehicle traveling along a route, comprising:
electronically generating a turn notification signal upon electronically determining that the vehicle is approaching a turn along the route; and
automatically illuminating at least one turn signal indicator associated with the vehicle in response to the turn notification signal, wherein the turn signal indicator is external to the vehicle.

15. The method of claim 14, wherein generating the turn notification signal comprises determining the location of the vehicle relative to the location of the turn.

16. The method of claim 15, wherein determining the location of the vehicle comprises use of a Global Positioning System.

17. The method of claim 15, wherein determining the location of the vehicle relative to the location of the turn comprises determining whether the location of the vehicle is within a certain distance of the turn.

18. The method of claim 14, wherein generating the turn notification signal comprises use of a server in wireless communication with the vehicle.

19. The method of claim 14, wherein the turn signal indicator is independently activatable by a driver of the vehicle.

20. The method of claim 19, wherein the turn signal indicator is independently activatable by the driver by manipulating a lever coupled to a steering column in the vehicle.

21. The method of claim 14, further comprising audibly broadcasting an audible turn notification within the vehicle in response to the turn notification signal.

22. The method of claim 21, wherein the audible turn notification comprises a voice specifying the nature of the upcoming turn.

23. The method of claim 14, wherein the audible turn notification emulates the sound heard upon engagement of an electromechanical device.

24. The method of claim 14, further comprising allowing the driver to override the automatically illuminated turn signal indicator.

25. The method of claim 14, further comprising disabling the illumination of the illuminated turn signal after the vehicle has passed the turn.

26. The method of claim 14, wherein the at least one turn signal indicator is proximate to front and/or rear bumpers of the vehicle.

27. The method of claim 14, wherein the turn signal indicator is proximate to a side view mirror.

28. A method for notifying of an upcoming turn in a vehicle traveling along a route, comprising:
electronically generating a turn notification signal upon electronically determining that the vehicle is approaching a turn along the route; and
automatically illuminating at least one turn signal indicator associated with the vehicle in response to the turn notification signal, wherein the turn signal indicator is independently activatable by a driver of the vehicle using a turn signal selector.

29. The method of claim 28, wherein generating the turn notification signal comprises determining the location of the vehicle relative to the location of the turn.

30. The method of claim 29, wherein determining the location of the vehicle comprises use of a Global Positioning System.

31. The method of claim 29, wherein determining the location of the vehicle relative to the location of the turn comprises determining whether the location of the vehicle is within a certain distance of the turn.

32. The method of claim 28, wherein generating the turn notification signal comprises use of a server in wireless communication with the vehicle.

33. The method of claim 28, further comprising audibly broadcasting an audible turn notification within the vehicle in response to the turn notification signal.

34. The method of claim 33, wherein the audible turn notification comprises a voice specifying the nature of the upcoming turn.

35. The method of claim 28, wherein the audible turn notification emulates the sound heard upon engagement of an electromechanical device.

36. The method of claim 28, further comprising allowing the driver to override the automatically illuminated turn signal indicator.

37. The method of claim 28, further comprising disabling the illumination of the illuminated turn signal after the vehicle has passed the turn.

38. The method of claim 28, wherein the at least one turn signal indicator is proximate to front and/or rear bumpers of the vehicle.

39. The method of claim 28, wherein the turn signal indicator is proximate to a side view mirror.

40. The method of claim 28, wherein the turn signal indicator is proximate to an instrument cluster on a dashboard of the vehicle

41. The method of claim 28, wherein the turn signal selector comprises a lever.

42. The method of claim 41, wherein the lever is coupled to a steering column.

43. A method for notifying of an upcoming turn in a vehicle traveling along a route, comprising:
electronically generating a turn notification signal upon electronically determining that the vehicle is approaching a turn along the route; and
automatically illuminating at least one turn signal indicator associated with the vehicle in response to the turn notification signal, wherein the turn signal indicator is substantially within the line of sight of a driver of the vehicle.

44. The method of claim 43, wherein generating the turn notification signal comprises determining the location of the vehicle relative to the location of the turn.

45. The method of claim 44, wherein determining the location of the vehicle comprises use of a Global Positioning System.

46. The method of claim 44, wherein determining the location of the vehicle relative to the location of the turn comprises determining whether the location of the vehicle is within a certain distance of the turn.

47. The method of claim 43, wherein generating the turn notification signal comprises use of a server in wireless communication with the vehicle.

48. The method of claim 43, further comprising audibly broadcasting an audible turn notification within the vehicle in response to the turn notification signal.

49. The method of claim 48, wherein the audible turn notification comprises a voice specifying the nature of the upcoming turn.

50. The method of claim 43, further comprising allowing the driver to override the automatically illuminated turn signal indicator.

51. The method of claim 43, further comprising disabling the illumination of the illuminated turn signal after the vehicle has passed the turn.

52. The method of claim 43, wherein the at least one turn signal indicator is reflected from a windshield of a vehicle.

53. A system for notifying of an upcoming turn in a vehicle traveling along a route, comprising:
a controller for receiving a command for issuing a turn notification signal, wherein the turn notification signal indicates that the vehicle is approaching a turn along the route; and
at least one turn signal indicator for receiving the turn notification signal, wherein the turn signal indicator comprises at least one selected from the group consisting of:
an indicator proximate to an instrument cluster on a dashboard of the vehicle,
an indicator external to the vehicle, and
an indicator reflected from a windshield of a vehicle.

54. The system of claim 53, wherein the turn notification signal is generated by determining the location of the vehicle relative to the location of the turn.

55. The system of claim 54, wherein determining the location of the vehicle comprises use of a Global Positioning System.

56. The system of claim 54, wherein determining the location of the vehicle relative to the location of the turn comprises determining whether the location of the vehicle is within a certain distance of the turn.

57. The system of claim 53, further comprising a turn signal selector for allowing a driver of the vehicle to independently activate the turn signal indicator.

58. The system of claim 53, further comprising at least one speaker for audibly broadcasting an audible turn notification within the vehicle in response to the turn notification signal.

59. The system of claim 58, wherein the audible turn notification comprises a voice specifying the nature of the upcoming turn.

60. The system of claim 53, wherein the controller and the turn signal indicator are coupled through a vehicle bus.

61. The system of claim 53, wherein the controller is directly coupled to the turn signal indicator through a dedicated path.

62. The system of claim 53, wherein the external indicator is proximate at least one position selected from the group consisting of a hood of the vehicle, a bumper of the vehicle, a windshield of the vehicle, a side of the vehicle, and a hood ornament of the vehicle.

63. A system for notifying of an upcoming turn in a vehicle traveling along a route, comprising:
a controller for receiving a command for issuing a turn notification signal, wherein the turn notification signal indicates that the vehicle is approaching a turn along the route; and
at least one means responsive to the turn notification signal for indicating the direction of the upcoming turn.

64. The system of claim 63, wherein the means comprises at least one selected from the group consisting of:
an indicator proximate to an instrument cluster on a dashboard of the vehicle,
an indicator external to the vehicle, and
an indicator reflected from a windshield of a vehicle.

65. The system of claim 63, wherein the controller and the means are coupled through a vehicle bus.

66. The system of claim 63, wherein the controller is directly coupled to the turn signal indicator through a dedicated path.

67. The system of claim 63, wherein the external indicator is proximate at least one position selected from the group consisting of a hood of the vehicle, a bumper of the vehicle, a windshield of the vehicle, a side of the vehicle, and a hood ornament of the vehicle.
